(19) United States
(12) Patent Application Publication
(10) Pub. No.: US 2004/0125508 A1
(43) Pub. Date: Jul. 1, 2004

(54) Method and apparatus for forming a plurality of actuation devices on suspension structures for hard disk drive suspension

(75) Inventors: Xiao Yang, Fremont, CA (US); Visit Thaveeprungsriporn, Bangkok (TH); Szu-Han Hu, Bangkok (TH)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: KR Precision Public Company Limited, T. Lamsai, A. Wangnoi (TH)

(21) Appl. No.: 10/330,457

(22) Filed: Dec. 27, 2002

(51) Int. Cl. G11B 5/56

(52) U.S. Cl. 360/294.3

(57) ABSTRACT

A method for manufacturing a microactuator device. The method includes providing a first sheet of material. The first sheet of material includes a plurality of gimbal structure regions. Each of the gimbal structure regions is spatially disposed on the first sheet of material. Each of the gimbal structure regions is capable of removal during a subsequent process. The method also includes providing a second sheet of material. The second sheet of material includes a plurality of actuator devices thereon. Each of the actuator devices is spatially disposed on the second sheet of material. Each of the actuator devices has an attachment surface. The method includes positioning the first sheet of material to the second sheet of material such that at least one of the attachment surface of one of the actuator devices is aligned with at least one gimbal region. The attachment surface of the one of the actuator devices is coupled with the gimbal region to connect the attachment surface with the gimbal region. The method also releases the one actuator device from the second sheet of material to free the actuator device from the second sheet of material. Depending upon the embodiment, there can be other steps, as well.

### BACKGROUND OF THE INVENTION

This invention generally relates to techniques for operating a disk drive apparatus. More particularly, the present invention provides a method and apparatus for reading and writing information onto a computer disk commonly called a hard disk for storing data. Merely by way of example, the present invention is implemented using such method and apparatus with an actuating device coupled between a read/write head and support member for fine tuning the read/write head onto a data track on the hard disk, but it would be recognized that the invention has a much broader range of applicability.

Storage of information has progressed through the years. From the early days, primitive man stored information on walls of caves, as well as used writings on wood such as bamboo. Since then, people have used wood, silk, and papers as a media for writings. Paper has been bound to form books. Information is now stored electronically on disks, tape, and semiconductor devices. As merely an example, some of the early disks used magnetic technology to store bits of information in a digital manner onto the magnetic media. One of the first disk drives was discovered in the 1950's by International Business Machines of Armonk, N.Y.

Although such disks have been successful, there continues to be a demand for larger storage capacity drives. Higher storage capacity can be achieved in part by increasing an aerial density of the disk. That is, the density increases with the number of tracks per inch (TPI) and the number of bits per inch (BPI) on the disk.

As track density increases, however, the data track becomes narrower and the spacing between data tracks on the disk decreases. It becomes increasingly difficult for the motor and servo control system to quickly and accurately position the read/write head over the desired track. Conventional actuator motors, such as voice coil motors (VCM), often lack sufficient resolution and bandwidth to effectively accommodate high track-density disks. As a result, a high bandwidth and resolution second-stage microactuator is often necessary to precisely position the read/write head over a selected track of the disc.

Additionally, microactuators should also be cost effectively manufactured. Most microactuator devices are often fabricated in individual form, which is discrete and separate from others. Unfortunately, microactuators are often fragile, small in size, and difficult to handle effectively. Accordingly, complex assembly procedures are generally required to attach individual microactuator device elements to a suspension assembly. Such procedures are often inefficient and increases manufacturing cost, reduces yield, and causes longer throughput times.

Thus, there is a need for an improved high volume manufacturing process for microactuator devices.

### SUMMARY OF THE INVENTION

According to the present invention, techniques for operating a disk drive apparatus are provided. More particularly, the present invention provides a method and apparatus for reading and writing information onto a computer disk commonly called a hard disk for memory applications. Merely by way of example, the present invention is implemented using such method and apparatus using with an actuating device coupled between a read/write head and support member for fine tuning the read/write head onto a data track on the hard disk, but it would be recognized that the invention has a much broader range of applicability.

In a specific embodiment, the invention provides a method for assembling multiple microactuator devices onto the suspension in a batch process. The method includes forming multiple microactuator devices on a substrate such as stainless steel sheet, e.g., 305 Stainless Steel. Other materials such as glass, polyimids, silicon, or the like can be used. The microactuator device can be piezoelectric material such as PZT, or magnetic actuating element, electrostatic actuators, or any combination of these. The microactuator sheet is aligned and bonded to the loadbeam or trace gimbal sheet. The substrate material is removed during the stainless steel etch of the loadbeam or trace gimbal.

In an alternative specific embodiment, the invention provides a method for a disk drive apparatus, e.g., hard disk drive system. The apparatus has a magnetic disk for storing information, which includes a plurality of tracks. The method also includes a movable support member often called Head Gimbal Assembly or HGA coupled to the magnetic disk. The HGA includes a read/write head and a suspension. The suspension is comprised of a trace gimbal or TG and a loadbeam. The gimbal has a tongue portion. A slider device is coupled to the tongue portion. A read/write head is coupled to the slider device. The gimbal has certain stiffness that allows the read/write head to pitch and roll around a pivotal point at the center of the tongue. A drive device is coupled between the magnetic disk and the suspension. The primary drive device, e.g., a voice coil motor or VCM, is adapted to move the read/write head on a track on the magnetic disk using the suspension to suspend the read/write head over the disk at a distance of few nanometers. A second stage actuator device is integrated on the loadbeam or the gimbal. The actuator device is adapted to move the slider to a position normal to the track on the magnetic disk to align the read/write head on the track using a finer and faster alignment of the read/write head than the moveable support member driven by the VCM.

In an alternative specific embodiment, the invention provides a method for manufacturing a microactuator device. The method includes providing a first sheet of material. The first sheet of material includes a plurality of gimbal structure regions. Each of the gimbal structure regions is spatially disposed on the first sheet of material. Each of the gimbal structure regions is capable of removal during a subsequent process. The method also includes providing a second sheet of material. The second sheet of material includes a plurality of actuator devices thereon. Each of the actuator devices is spatially disposed on the second sheet of material. Each of the actuator devices has an attachment surface. The method includes positioning the first sheet of material to the second sheet of material such that at least one of the attachment surface of one of the actuator devices is aligned with at least one gimbal region. The attachment surface of the one of the actuator devices is coupled with the gimbal region to connect the attachment surface with the gimbal region. The method also releases the one actuator device from the second sheet of material to free the actuator device from the second sheet of material. Depending upon the embodiment, there can be other steps, as well.

Numerous benefits are achieved using the present invention over conventional techniques. The present invention can assembly multiple microactuator devices onto the suspension in a batch process instead of individually. As a result, this process not only increases yield and throughput, but also drives down manufacturing cost significantly, and ultimately makes microactuator a commercially viable solution for HDD applications. Additionally, the present invention can be implemented using existing fabrication technologies.

Additionally, the present invention can provide for alignment of a read/write head to track density of 250 k TPI (track per inch) or 100 Gbit/in² and greater at 4 kHz or greater. In certain embodiments, the present invention can be implemented using a small form factor, e.g., less than 100 microns in thickness, which results in no change in disk-disk spacing and causes little additional off-track error due to “windage effect.” The invention can also be easy to manufacture and apply according to certain embodiments. Depending upon the embodiment, one or more of these benefits may be used. These and other benefits are described throughout the present specification and more particularly below.

Various additional objects, features and advantages of the present invention can be more fully appreciated with reference to the detailed description and accompanying drawings that follow.

### BRIEF DESCRIPTION OF THE DRAWINGS

FIG. 1 is a simplified top-view diagram of a disk drive apparatus according to an embodiment of the present invention;

FIG. 2 is a more detailed side-view diagram of a disk drive suspension assembly according to an embodiment of the present invention;

FIG. 3 is a detailed diagram of a disk drive suspension assembly with PZT microactuator integrated on the gimbal according to an embodiment of the present invention;

FIG. 4 is a detailed diagram of a substrate sheet whereupon multiple trace gimbal are formed;

FIG. 5 is a detailed diagram of a substrate sheet whereupon multiple microactuator devices are formed;

FIG. 6 is a detailed diagram of a reinforced substrate sheet with multiple microactuator devices;

FIG. 7 is a detailed diagram of a trace gimbal with microactuators attached in sheet form;

FIG. 8 is a detailed diagram of a singulated street of bonded trace gimbal with microactuators attached;

FIG. 9 is a detailed side-view diagram of a microactuator sheet and a trace gimbal sheet before bonding;

FIG. 10 is a detailed side-view diagram of a microactuator sheet and a trace gimbal sheet after bonding;

FIG. 11 is a detailed side-view diagram of a bonded microactuator sheet and a trace gimbal sheet with backside stainless steel photolithography and photoresist patterning; and

FIG. 12 is a detailed side-view diagram of a trace gimbal with microactuator attached after backside stainless steel etch.

### DESCRIPTION OF THE SPECIFIC EMBODIMENTS

According to the present invention, techniques for operating a disk drive apparatus are provided. More particularly, the present invention provides a method and apparatus for reading and writing information onto a computer disk commonly called a hard disk for memory applications. Merely by way of example, the present invention is implemented using such method and apparatus using with an actuating device coupled between a read/write head and support member for fine tuning the read/write head onto a data track on the hard disk, but it would be recognized that the invention has a much broader range of applicability.

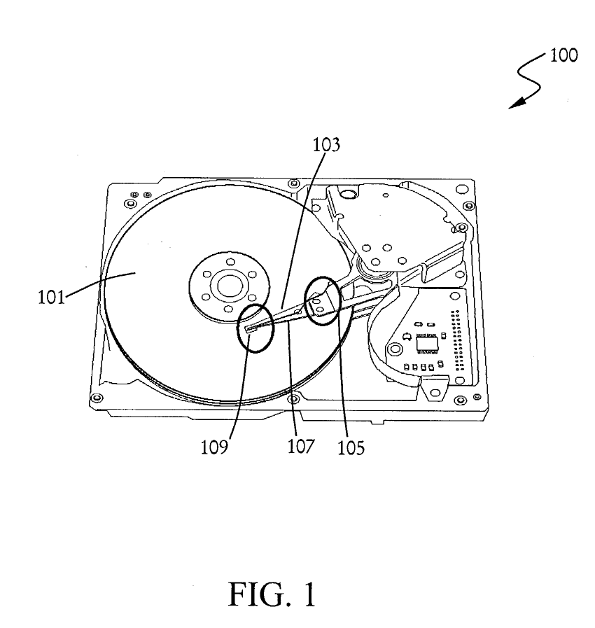

FIG. 1 is a simplified top-view diagram 100 of a disk drive apparatus according to an embodiment of the present invention. This diagram is merely an example, which should not unduly limit the scope of the claims herein. One of ordinary skill in the art would recognize many other variations, modifications, and alternatives. As shown, the apparatus 100 includes various features such as disk 101, which rotates about a fixed axis. The disk also includes tracks, which are used to store information thereon. The disk rotates at 7,200 RPM to greater than about 10,000 depending upon the embodiment. The disk, commonly called a platter, often includes a magnetic media such as a ferromagnetic material, but can also include optical materials, common coated on surfaces of the disk, which become active regions for storing digital bit information. Overlying the disk is head gimbal assembly or HGA 103, which operates and controls a slider 109 coupled to a read/write head. The head gimbal assembly is coupled to suspension 107 which couples to an arm 105. The arm is coupled to a voice coil motor or VCM, which moves the head assembly about a pivot point in an annular manner. The VCM can move at a frequency of up to about 1 kHz. Preferably, for high track density, e.g. 250 k TPI, the speed is at least 5 kHz, but can also be greater in certain embodiments.

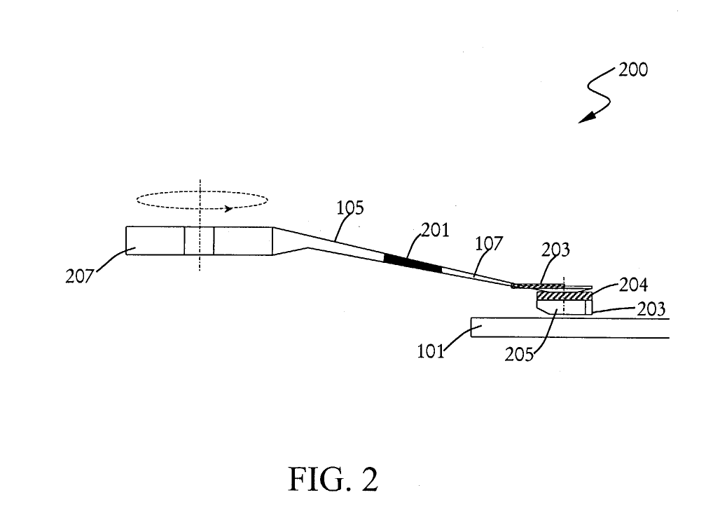

FIG. 2 is a more detailed side-view diagram of a disk drive arm assembly 200 according to an embodiment of the present invention. This diagram is merely an example, which should not unduly limit the scope of the claims herein. One of ordinary skill in the art would recognize many other variations, modifications, and alternatives. Like reference numerals are used in this diagram as certain other diagrams herein, which should not be limiting. As shown, the assembly includes suspension 107 coupled to arm 105 coupled to voice coil motor 207. The voice coil motor allows the arm to move in a rotational manner about a region of the disk drive platter. The voice motor coil often actuates at a frequency of less than 1 kHz, but can be slightly more depending upon the application. Slider 205 is coupled to another end of the suspension, which is often the free end of the suspension. The slider includes read/write head 203. The head is positioned over a track on the platter 101, which is among a plurality of tracks on the disk. Each of the tracks is spaced from each other at a dimension of less than one half of a micron in preferred embodiments.

Preferably, the head gimbal assembly also includes a microactuator device 201 coupled between the arm and suspension. Here, the microactuator device moves the head in a manner normal to the track. Preferably, the microactuator device allows for movement of up to 1 micron, but is accurate to about a few nanometers in preferred embodiments. The microactuator can move using a frequency of 2 kHz, but can also be greater, depending upon the application. Alternatively, the microactuator can be integrated on the trace gimbal 203, closer to the slider. Here, the microactuator device moves the head in a manner normal to the track. Preferably, the microactuator device allows for movement of up to 1 micron, but is accurate to about a few nanometers in preferred embodiments. The microactuator can move using a frequency of 4 kHz, but can also be greater, depending upon the application. Alternatively, the microactuator can also be ‘collocated’ between the gimbal and the slider 204. The actuating device moves the head in a direction normal to a direction of the track according to a specific embodiment. Preferably, the microactuator device allows for movement of up to 1 micron, but is accurate to about a few nanometers in preferred embodiments. The microactuator can move using a frequency of 5 kHz, but can also be greater, depending upon the application.

Preferably, the actuating device is made of a piezoelectric material such as PZT, which is operable in the transverse mode, but can also be in other modes such as shear mode and bending mode. The actuator device allows the read/write head to move in very small and accurate steps, e.g., less than 1 micron, but can also be slightly greater in certain applications. Further details on a method of fabricating the PZT material can be found in U.S. application Ser. No. ______ (Attorney Docket No. 021612-000600US), commonly assigned and hereby incorporated by reference in its entirety for all purposes.

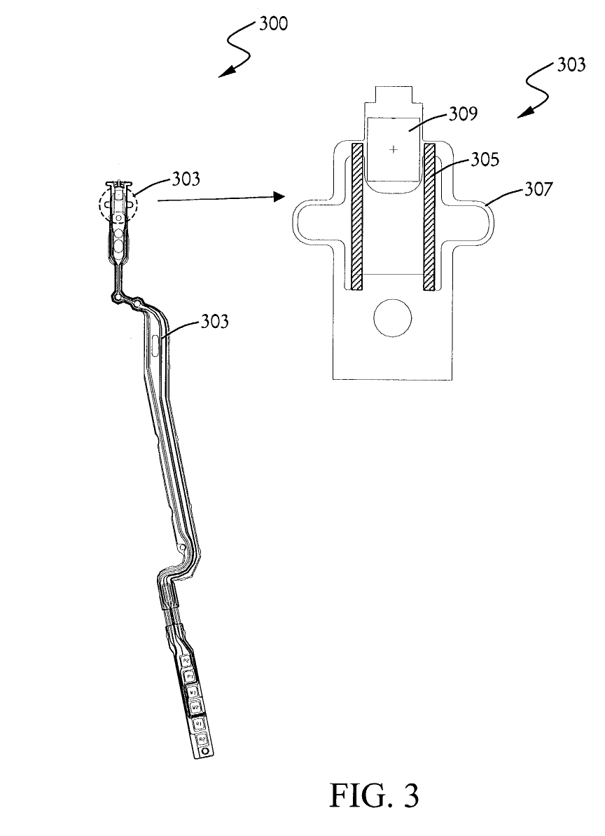

FIG. 3 is a detailed diagram of a trace gimbal assembly 300 according to an embodiment of the present invention. This diagram is merely an example, which should not unduly limit the scope of the claims herein. One of ordinary skill in the art would recognize many other variations, modifications, and alternatives. Like reference numerals are used in this figure as others, but are not intended to be limiting. As shown, the trace gimbal 301 includes a head portion 303. As merely an example, a pair of PZT elements are integrated on the head portion of the gimbal with folded spring 307, which provide a counteracting force to the pair of PZT elements, which work against the folded spring. The PZT actuating devices is operable in the transverse mode, but can also be in other modes such as shear mode and bending mode. The slider 309 rotates around the center or moves linearly depending upon an embodiment of the present invention. Preferably, the slider rotates through an angle of about 0.2 degrees, but can also be more or less depending upon the application. The read/write head can move about 1 microns or less based upon the angle of movement of the slider, depending upon the application. During the rotation of the slider, one of the pairs of PZT actuating devices increases in length and the other decreases in length, which causes the rotational movement. Of course, there can be many other variations, alternatives, and modifications.

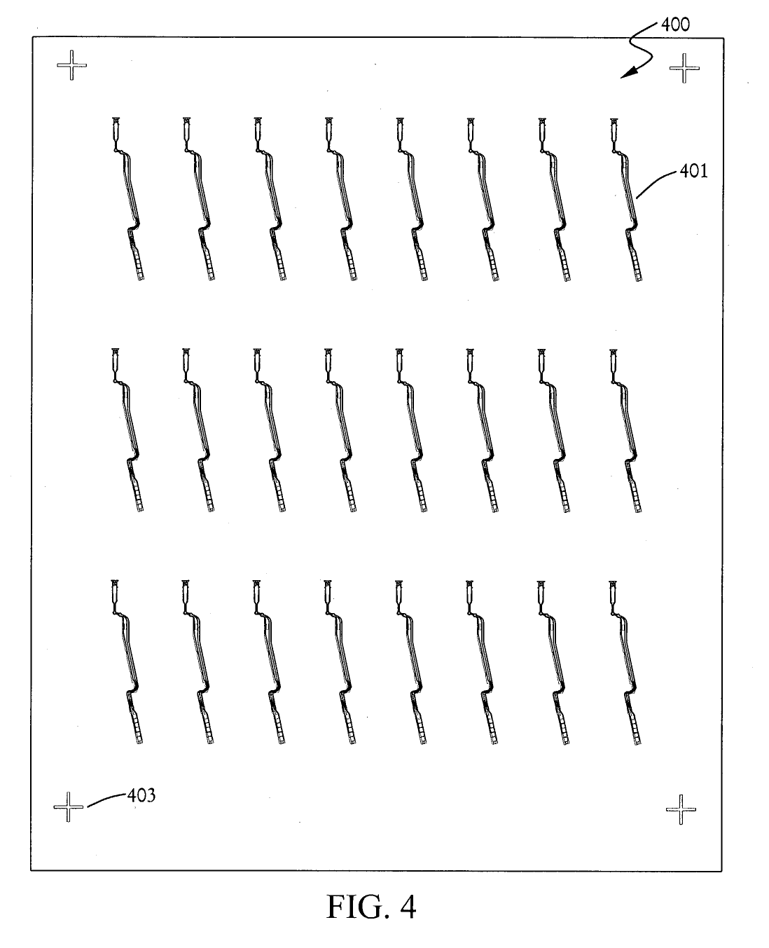

FIG. 4 is a detailed diagram of a trace gimbal sheet 400 according to an embodiment of the present invention. This diagram is merely an example, which should not unduly limit the scope of the claims herein. One of ordinary skill in the art would recognize many other variations, modifications, and alternatives. Like reference numerals are used in this figure as others, but are not intended to be limiting. As shown, the trace gimbal sheet 400 includes a plurality of individual trace gimbal 401. The sheet is made of a suitable material that is somewhat rigid and has enough structural support to form the gimbal structures. Preferably, the sheet is made of a stainless steel material, which has a thickness of about 25 microns and is substantially even in thickness in certain applications. Each of the trace gimbal structures is separated from each other in a spatial arrangement for mass production. Each of the structures has been formed in part through photolithography and other processing steps, which are commonly known in the lart.

The sheet of material also includes a plurality of alignment marks. The alignment mark 403 provides accurate alignment during fabrication process of the trace gimbal and bonding of the microactuator onto the gimbal. Preferably, each of the alignment marks is positioned in a spatial manner along corners of the sheet of material for improved accuracy. Depending upon the application, there are at least two alignment marks. Alternatively, there are more than two or even four alignment marks in other embodiments. Further details of such alignment marks are described throughout the present specification and more particularly below.

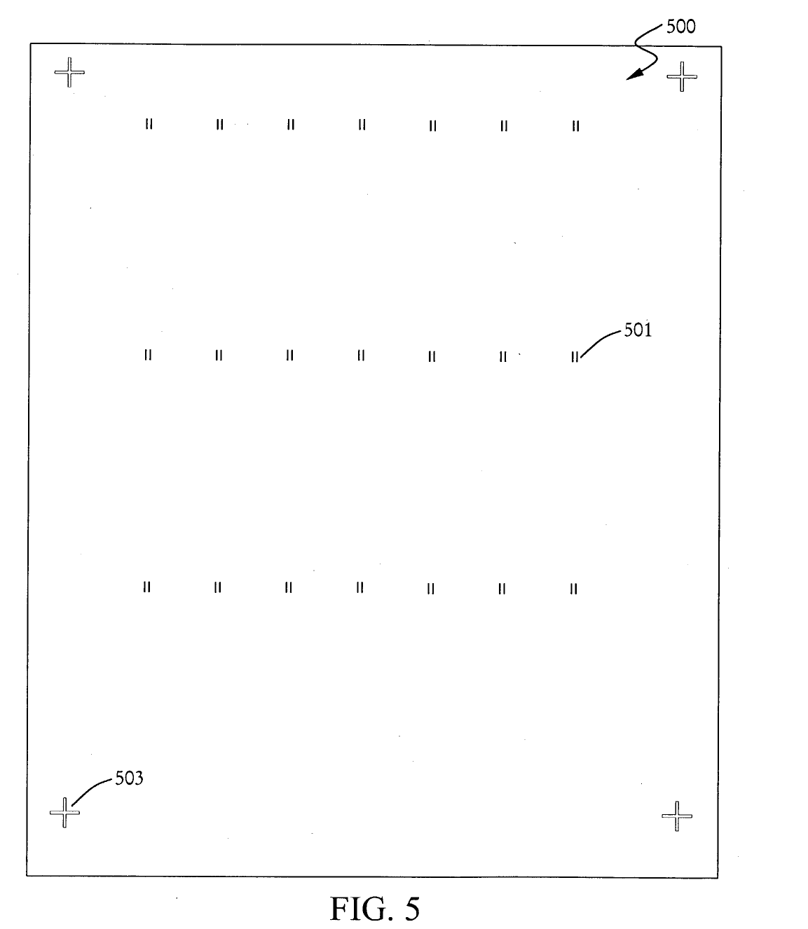

FIG. 5 is a detailed diagram of a microactuator sheet 500 according to an embodiment of the present invention. This diagram is merely an example, which should not unduly limit the scope of the claims herein. One of ordinary skill in the art would recognize many other variations, modifications, and alternatives. Like reference numerals are used in this figure as others, but are not intended to be limiting. As shown, the microactuator sheet 500 includes a plurality of individual microactuator 501. As merely an example, the microactuator can be piezoelectric material such as PZT. A PZT paste is formed and stencil or screen printed onto the substrate. A sintering process is followed to densify the PZT material. Similarly, electrodes can be also formed by a printing process. As merely an example, details of ways to form the PZT are illustrated in U.S. application Ser. No. ______ (Attorney Docket No. 021612-000600US), commonly assigned and hereby incorporated by reference in its entirety for all purposes. The alignment mark 503 matches the alignment mark on the trace gimbal sheet and provides accurate alignment during the bonding of the microactuator sheet onto the gimbal sheet. The location of each individual microactuator corresponds to its trace gimbal on the trace gimbal sheet.

Optionally, the method includes a sintering temperature that ranges from 1100-1300° C. This temperature is above the melting temperature of the copper (1084° C.) and polyimide (400° C.) on the trace gimbal. The high temperature often prevents directly form (e.g., print, sputter, deposit) PZT material on the trace gimbal sheet. However, certain process is able to form PZT element under 200° C. In this case, the PZT material can be directly formed onto the trace gimbal sheet and further simplifies the manufacturing integration process. Of course, the particular technique used depends upon the application.

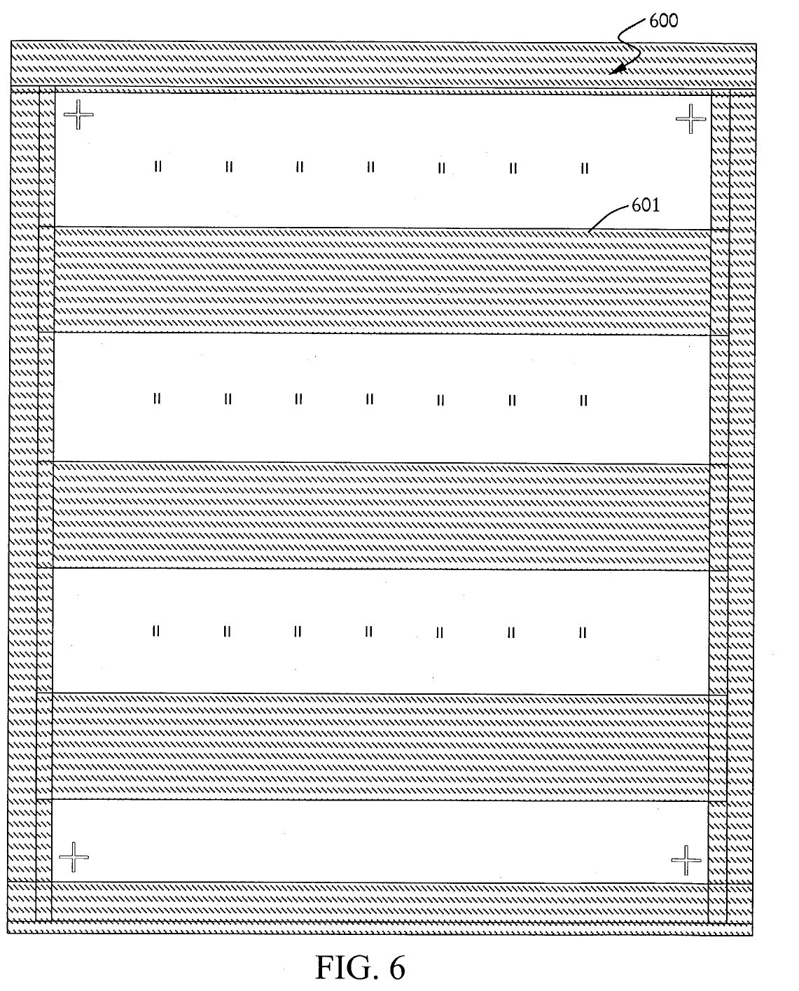

FIG. 6 is a detailed diagram of a microactuator sheet 600 with reinforce frame according to an embodiment of the present invention. This diagram is merely an example, which should not unduly limit the scope of the claims herein. One of ordinary skill in the art would recognize many other variations, modifications, and alternatives. Like reference numerals are used in this figure as others, but are not intended to be limiting. As shown, the microactuator sheet 600 includes microactuator sheet with reinforce frame 601, which acts as a support for the sheet. The sheet is often difficult to handle without the reinforcement frame according to certain embodiments. The reinforce frame provides mechanical strength and rigidity to ensure accurate alignment during the bonding of the microactuator sheet onto the gimbal sheet. The reinforcement frame is coupled to the sheet using a suitable attachment material.

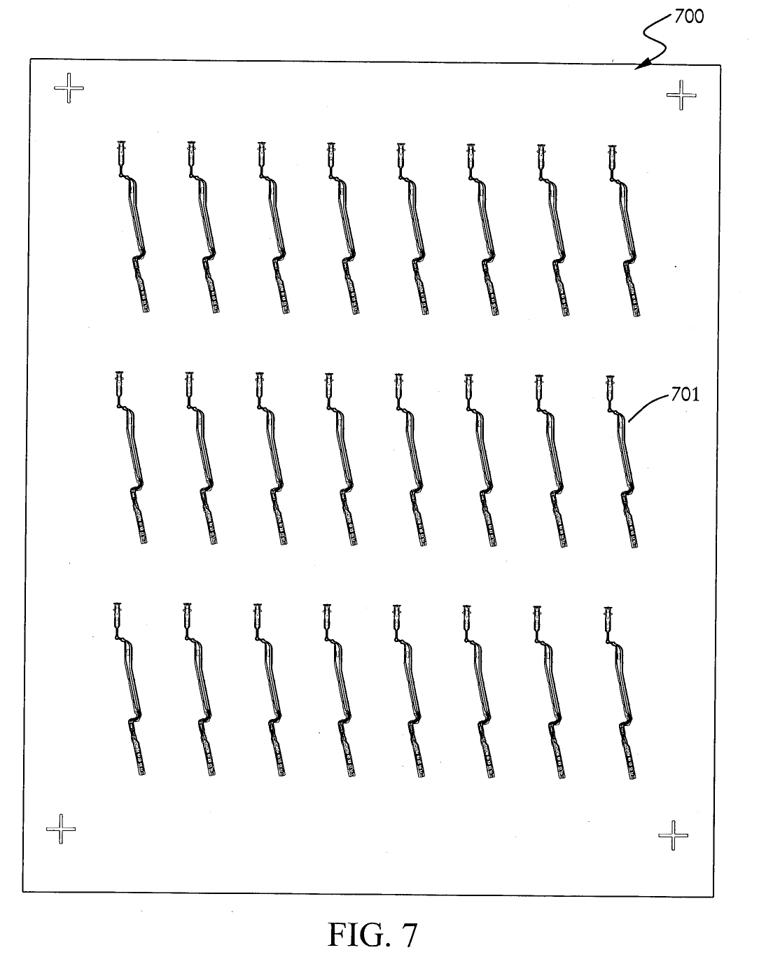

FIG. 7 is a detailed diagram of a trace gimbal with microactuator sheet 700 with reinforce frame according to an embodiment of the present invention. This diagram is merely an example, which should not unduly limit the scope of the claims herein. One of ordinary skill in the art would recognize many other variations, modifications, and alternatives. Like reference numerals are used in this figure as others, but are not intended to be limiting. As shown, the trace gimbal sheet 700 includes individual microactuator attached to its corresponding trace gimbal at specified location 701.

Preferably, the present invention includes a method for manufacturing a microactuator device using the sheet of actuators and trace gimbal structures. As noted, the method includes providing a first sheet of material. The first sheet of material includes a plurality of gimbal structure regions. Each of the gimbal structure regions is spatially disposed on the first sheet of material. Each of the gimbal structure regions is capable of removal during a subsequent process. The method also includes providing a second sheet of material. The second sheet of material includes a plurality of actuator devices thereon. Each of the actuator devices is spatially disposed on the second sheet of material. Each of the actuator devices has an attachment surface. The method includes positioning the first sheet of material to the second sheet of material such that at least one of the attachment surface of one of the actuator devices is aligned with at least one gimbal region. The attachment surface of the one of the actuator devices is coupled with the gimbal region to connect the attachment surface with the gimbal region. The method also releases the one actuator device from the second sheet of material to free the actuator device from the second sheet of material. Depending upon the embodiment, there can be other steps, as well. Further details of the present method are provided throughout the present specification and more particularly below.

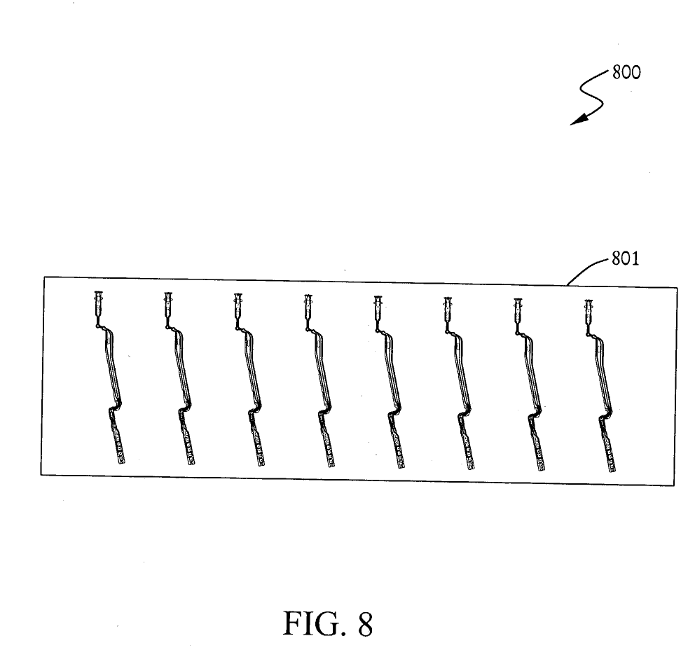

FIG. 8 is a detailed diagram of a singulated trace gimbal array 800 with reinforce frame according to an embodiment of the present invention. This diagram is merely an example, which should not unduly limit the scope of the claims herein. One of ordinary skill in the art would recognize many other variations, modifications, and alternatives. Like reference numerals are used in this figure as others, but are not intended to be limiting. As shown, the trace gimbal array 800 includes array of trace gimbal with individual microactuator attached to its corresponding trace gimbal 801. The gimbal trace array is then ready to be assembled with load beams to form suspensions. Here, the trace gimbals are provided in strips, which are at least one by n, where n is an integer greater than 1.

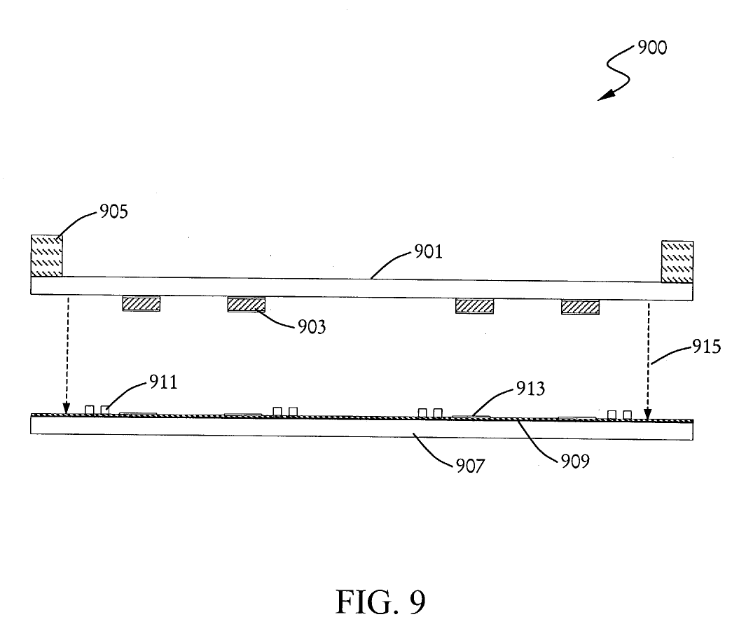

FIG. 9 is a detailed side-view diagram of a trace gimbal sheet and microactuator sheet before bonding according to an embodiment of the present invention. This diagram is merely an example, which should not unduly limit the scope of the claims herein. One of ordinary skill in the art would recognize many other variations, modifications, and alternatives. Like reference numerals are used in this figure as others, but are not intended to be limiting. As shown, the microactuator sheet includes the stainless steel substrate 901 with preformed PZT elements 903. The reinforce frame 905 provides mechanical strength and rigidity to ensure accurate alignment during the bonding of the microactuator sheet onto the gimbal sheet. The trace gimbal sheet includes a stainless steel substrate 907 with polyimide 909 as the insulation layer. Copper traces 911 are formed on top of the insulation layer. An adhesion layer 913 is patterned to match the footprint of the PZT elements. Before bonding, the two sheets are accurately aligned 915 such that each of the gimbal structures aligns with a corresponding PZT element for improved processing.

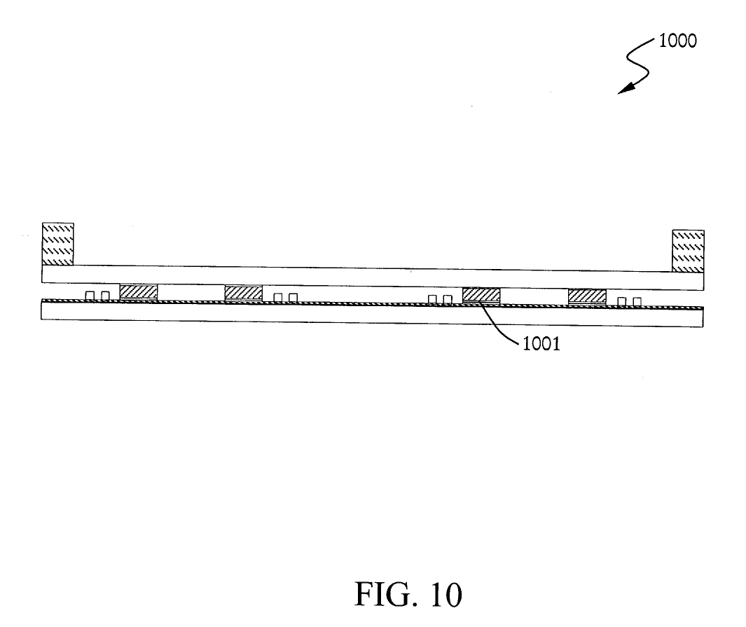

FIG. 10 is a detailed side-view diagram of a trace gimbal sheet and microactuator sheet after bonding according to an embodiment of the present invention. This diagram is merely an example, which should not unduly limit the scope of the claims herein. One of ordinary skill in the art would recognize many other variations, modifications, and alternatives. Like reference numerals are used in this figure as others, but are not intended to be limiting. As shown, the microactuator sheet and the trace gimbal sheet are bonded with a bonding interface 1001. Preferably, bonding is provided using an adhesive. Such adhesive is commonly an epoxy or other like material, which is capable of affixing the PZT element to the gimbal structure. The adhesive can be permanent or substantially permanent according to a specific embodiment.

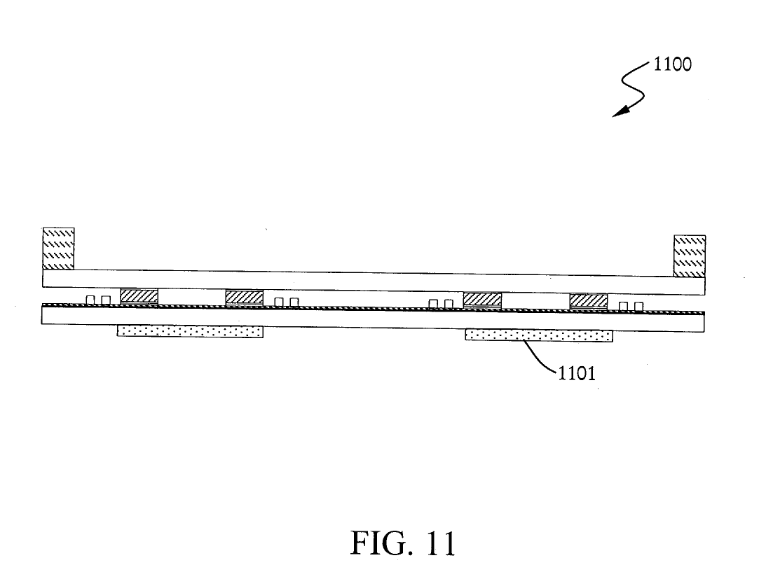

FIG. 11 is a detailed side-view diagram of a bonded trace gimbal sheet and microactuator sheet with photolithography patterns according to an embodiment of the present invention. This diagram is merely an example, which should not unduly limit the scope of the claims herein. One of ordinary skill in the art would recognize many other variations, modifications, and alternatives. Like reference numerals are used in this figure as others, but are not intended to be limiting. As shown, photoresist material is patterned on the backside of the trace gimbal sheet 1101. The photoresist material is often a positive resist, which is used for masking purposes. The exposed stainless steel and polyimide on the trace gimbal sheet will be etched. Etching takes place using at least a dry or wet etching process, which will be described more fully below. The stainless steel substrate for the PZT will also be etched in the same process according to a preferred embodiment.

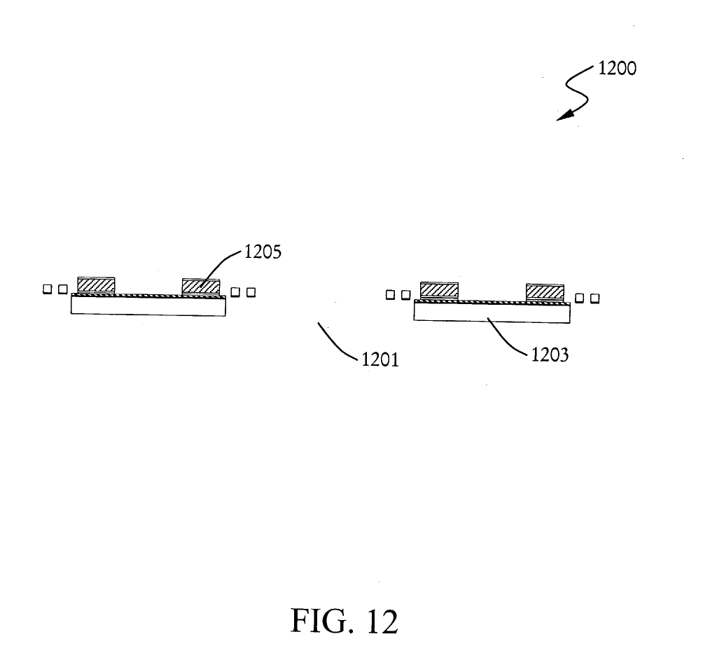

FIG. 12 is a detailed side-view diagram of etched trace gimbal according to an embodiment of the present invention. This diagram is merely an example, which should not unduly limit the scope of the claims herein. One of ordinary skill in the art would recognize many other variations, modifications, and alternatives. Like reference numerals are used in this figure as others, but are not intended to be limiting. As shown, the exposed stainless steel and polyimide on the trace gimbal sheet is etched off 1201. The remaining stainless steel portion forms the gimbal 1203. The stainless steel substrate for the PZT is also etched off in the same process. The PZT elements are released from its original stainless substrate 1205. Preferably, etching is provided using a wet etchant such as HNO₃+HCl, HCl, HCl+FeCl₃, and others.

One of ordinary skill in the art would recognize many other variations, modifications, and alternatives. The above example is merely an illustration, which should not unduly limit the scope of the claims herein. It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A disk drive apparatus, the apparatus comprising:
a magnetic disk for storing information, the magnetic disk comprising a plurality of tracks;
a movable support member coupled to the magnetic disk, the movable support member having a tongue portion and a gimble portion, the tongue portion being coupled the gimbal portion;
a slider device coupled to the tongue portion;
a read/write head coupled to the slider device;
a drive device coupled between the magnetic disk and the movable support member, the drive device being adapted to move the read/write head on a track on the magnetic disk using the movable support member about a fixed pivot position;
a second-stage actuator device being adapted to move the read/write head relative to the slider device to a position normal to the track on the magnetic disk to align the read/write head on the track using a finer alignment of the read/write head than the moveable support member;
a second-stage actuator device being fabricated in batch on a substrate and bonded to a trace gimbal sheet.

2. The apparatus of claim 1 wherein movable support member is provided in a suspension assembly.

3. The apparatus of claim 1 wherein the drive device is a voice coil motor.

4. The apparatus of claim 1 wherein second-stage actuator device is a piezoelectric material coupled between the arm and the suspension.

5. The apparatus of claim 1 wherein second-stage actuator device is a piezoelectric material integrated on the trace gimbal.

6. The apparatus of claim 1 wherein second-stage actuator device is a piezoelectric material coupled between the gimbal and slider.

7. The apparatus of claim 1 wherein the actuating device is a piezoelectric material, the piezoelectric material being adapted to working in a transverse mode, or a shear mode, or a bending mode to allow the read/write head to move relative to the slider device.

8. The apparatus of claim 1 wherein the actuating devices substrate is a stainless steel sheet.

9. The apparatus of claim 1 wherein the actuating devices are being fabricated in batch on a substrate.

10. A method for manufacturing a microactuator device, the method comprising:
providing a first sheet of material, the first sheet of material including a plurality of gimbal structure regions, each of the gimbal structure regions being spatially disposed on the first sheet of material, each of the gimbal structure regions being capable of removal during a subsequent process;
providing a second sheet of material, the second sheet of material including a plurality of actuator devices thereon, each of the actuator devices being spatially disposed on the second sheet of material, each of the actuator devices having a attachment surface;
positioning the first sheet of material to the second sheet of material such that at least one of the attachment surface of one of the actuator devices is aligned with at least one gimbal region;
coupling the attachment surface of the one of the actuator devices with the gimbal region to connect the attachment surface with the gimbal region; and
releasing the one actuator device from the second sheet of material to free the actuator device from the second sheet of material.

11. The method of claim 10 further comprising pattering the gimbal region to release the gimbal region from the first sheet of material.

12. The method of claim 11 wherein the pattering of the gimbal region and the removing are provided simultaneously using at least an etching process.

13. The method of claim 10 wherein each of the actuator devices comprises a plurality of PZT elements.

14. The method of claim 10 wherein the releasing is provided by at least an etching process.

15. The method of claim 10 wherein the first sheet of material comprises a stainless steel material.

16. The method of claim 10 wherein the second sheet of material comprises a stainless steel material.

17. The method of claim 10
wherein at least a first attachment surface, a second attachment surface, and an nth attachment surface, where n is an integer greater than 2, are respectively aligned with a first gimbal region, a second gimbal region, and a mth gimbal region, where m is the same integer as n;
wherein the first attachment surface, the second attachment surface and the nth attachment surface are respectively coupled with the first gimbal region, the second gimbal region, and the mth gimbal region to connect the first attachment surface to the first gimbal region, to connect the second attachment surface to the second gimbal region, and to connect the nth attachment surface to the mth gimbal region; and
wherein the first actuator device, the second actuator device, and the nth actuator device are released from the second sheet of material.

18. The method of claim 17 wherein the aligning is provided using at least a first set of alignment marks on the first sheet coupled to a second set of alignment marks on the second sheet.
